(19) United States
(12) Patent Application Publication
(10) Pub. No.: US 2001/0055309 A1
(43) Pub. Date: Dec. 27, 2001

(54) System and method for communicating between distant regions

(76) Inventor: David Altstaetter, Plano, TX (US)

Correspondence Address: WORLDCOM, INC., TECHNOLOGY LAW DEPARTMENT, 1133 19TH STREET NW, WASHINGTON, DC, 20036, US

(21) Appl. No.: 09/824,393

(22) Filed: Apr. 2, 2001

Related U.S. Application Data
(60) Provisional application No. 60/193,472, filed on Mar. 31, 2000.

(51) Int. Cl. H04L 12/28

(52) U.S. Cl. 370/403; 370/419

(57) ABSTRACT

A system of communication between distant regions is provided that solves the problems inherent in the present state of similar systems. The redundancy of the ADMs at each terminating site is eliminated, replacing the more costly ADM with a standard switching device. The switching devices are electrical, optical or wireless in nature, for example, a standard multiplexer or optical cross-connect switch. A second advantage is the elimination of the redundancy of connections between the terminating sites, as well as a reduction in cost and an increase in system-wide reliability.

### CROSS-REFERENCES TO RELATED APPLICATIONS

This application is related to, and claims the benefit of the earlier filing date of U.S. Provisional Patent Application No. 60/193,472, filed Mar. 31, 2000, entitled “Transoceanic Communication System and Method,” the entirety of which is incorporated herein by reference.

### BACKGROUND OF THE INVENTION

1. Field of the Invention

The present invention relates to a system and method for communicating between distant regions, and more particularly, to a system and method for switching and routing communications data in transoceanic communication systems.

2. Description of the Related Art

One form of transoceanic communications involves laying cable, containing electrical conductors or optical fibers, along the ocean floor and terminating the cable at equipment sites on land at either end of the cable. The reliability of a transoceanic communications system is often improved by using two cables terminating, at both ends, at different points on land. This provides some spatial diversity so that a cable cut or equipment malfunction affecting one cable is unlikely to affect the other cable.

FIG. 1 of the accompanying drawings illustrates a traditional transoceanic cable system comprising two separate cables. Optical fiber cables 170 and 172 are shown spanning across an ocean, but can span any region that presents economical or physical constraints in its construction and maintenance. A cable buried deep under the ocean is inaccessible, but nevertheless is subject to failure. In this context, it is impractical to erect, and provide power to, a network of equipment sites along the cable to permit, for example, a diversely routed mesh structure to be formed out at sea that would improve the reliability of the transoceanic span. A similar situation is foreseen where communications are attempted from one region to another region through intervening air or space, or spanning hostile environments or large undeveloped areas such as jungles, forests, mountains or deserts. The intervening area to be spanned may be in political unrest, such as a combat zone or an otherwise sensitive area, thus preventing even routine maintenance.

The information conduits themselves may take the form of electrical or optical cables or may be a radio communication path. In all of these instances, reliable communications may be achieved through redundant but diversely routed spans to make up for the relative inaccessibility of the long spans. Ring networks are used in each region to provide landing site diversity and the interconnections between the rings are expressly provided for the purpose of spanning a lengthy inaccessible intervening region.

Referring again to FIG. 1, the span provides communications between landmass 104 and landmass 106. Upon failure of either cable 170 or 172 due to damage or equipment failure, the transoceanic connection is readily restored using the other cable to circumvent the failure through the use of protective switching schemes. The familiar self-healing ring design can be employed to facilitate this protective switching. This is accomplished by providing two additional fiber spans 174 and 176 between each pair of on-land terminating points of cable 170 and 172, that is, between sites 144 and 146, and 152 and 158, respectively. Using an Add-Drop Multiplexer (ADM) at each terminating point, this arrangement forms a self-healing ring network structure, such as a bi-directional line switched ring network, the design and operation of which is well-known and understood among those of ordinary skill in the art.

Furthermore, to provide some protection against terrestrial failures and to make terrestrial and submarine failures independent of one another, so-called “backhaul rings” are used at both terrestrial ends to couple traffic to the transoceanic ring. In FIG. 1 one such backhaul ring network is shown comprising sites 142, 144, 146, and 148 as interconnected by a series of links or conduits. The links are cables, optical fibers, wireless systems, or the like. Thus, span 190, comprised of two cables 162 and 174, also referred to as an “interlink” span, traditionally comprises one link that is part of a transoceanic ring (e.g. cable 174) and one link that is part of the backhaul ring network (e.g. cable 162). Accordingly, the transoceanic ring is formed by cables 170 and 172, sites 144, 152, 158, and 146, and interlink spans 190 and 192 (more particularly, cables 174 and 176) on landmasses 104 and 106. The net result is a three-ring structure with two nodes of each backhaul ring network coupled to two nodes of the transoceanic ring network.

The node of the system is a point along the ring where traffic may be added, dropped, or merely passed along, usually via an ADM. In some cases, the node may also comprise passive optical switches. The node has two or three input/output ports depending on its particular use in the ring structure. For example, as shown in FIG. 2, node 148 is a 2-port node; data enters into ADM 118 and is passed along to ADM 116 of node 146. Node 142 is a 3-port node containing ADM 112; data enters into ADM 112 of node 142 via input ports 180, and depending on the switch configuration of ADM 112, the data can be transmitted to node 144 or node 148.

At each site where a terrestrial backhaul node adjoins a transoceanic node, the traffic is dropped from one ADM at a tributary rate and enters an adjoining node ADM at the tributary rate. The term “tributary” means that the data rate along a conduit is a fraction of the aggregate rate that is actually transmitted over the cable. For example, if an OC-192 optical signal transmitted at about 10 gigabits-per-second is received by ADM 114 the signal may be multiplexed into four tributary data streams of about 2.5 gigabits-per-second each transmitted across a connection of link 164. As shown in FIG. 2, tributary connection 164 carries data extracted by ADM 114 from backhaul ring 110 and passes the extracted data to ADM 124 to be carried by transoceanic ring 120.

With reference to FIGS. 1 and 2, the following is an example of data communications under normal circumstances in the traditional three-ring network architecture. Information to be communicated is submitted along data inputs 180 and enters backhaul ring network 110 through ADM 112 of node 142. The information proceeds to node 144, wherein ADM 114 passes the data to ADM 124 over tributary connection(s) 164. The data is sent along transoceanic cable 170 to reach ADM 122 of node 152. At ADM 122 the information is “dropped” from transoceanic ring network 120 and coupled into backhaul ring network 130 via ADM 132. The information travels through backhaul ring 130 via ADM 134 of node 154 and reaches its destination at ADM 136 of node 156 where it is delivered to output ports 182. As shown in FIG. 2 and as described above, the dashed line throughout the figures depicts the routing path of the data. Also shown in FIG. 2 are ADMs 126, 128 and 138, cables 162 and 174 (taken together referred to as interlink span 190), and cables 176 and 188 (taken together referred to as interlink span 192), and node 158.

Traditional three ring networks, such as shown in FIG. 2, include the pairing of ADMs (i.e. 114/124, 116/126, 122/132, and 128/138) at a given terminating point site (i.e. 144, 146, 152 and 158, respectively), as well as the duplication of cables or fibers (i.e. 162/174 and 176/188). This pairing of ADMs and duplication of cables or fibers greatly adds to the overall cost of the system and also adds additional elements that are prone to failure.

This arrangement of ADMs to form adjoining rings are shown to be reliable against many site outages, tributary failures, terrestrial span outages, transoceanic span outages, and combinations thereof. Several terms are used throughout the industry to describe this common configuration, including, “matched-node configuration,” “dual ring interconnect,” and “dual junction.” There are also existing mechanisms and protocols, such as standardized Alarm Indication Signals (AIS) or Automatic Protect Switching (APS) schemes (e.g. K1/K2 bytes in SONET overhead), by which ADMs may be informed of failed connections by other ADMs.

FIGS. 3 through 8 depict the traditional three-ring network architecture of FIGS. 1 and 2 under various failure conditions and indicate how traffic may be routed to maintain communications. Throughout the figures, similar references refer to similar elements.

FIG. 3 depicts the three-ring network of FIG. 2 with a failure of cable 160. When a failure similar to this occurs, ADM 114 sends an AIS throughout the system notifying it that ADM 114 is not receiving data. By utilizing an APS scheme, ADM 112 reroutes the data and transmits the data to ADM 118 via cable 161. The system then routes the data along the path shown by the dashed line, i.e. along cable 171, through ADM 116, along cable 162, through ADM 114, thereby circumventing the failure, and eventually to data output ports 182. The data is successfully rerouted.

In FIG. 4 transoceanic cable 170 fails. Upon the failure of cable 170, ADM 122 of node 152 detects no data and sends an AIS throughout the system. ADM 124 switches its data path through cable 174 under a preset APS scheme. The data travels to ADM 126 of node 146 where it is switched onto cable 172. The data arrives at ADM 128 of node 158 where it is switched to cable 176. The data arrives at ADM 122, thus circumventing the failure, and sent along its normal path to data output ports 182.

In FIG. 5 tributary link 164 fails. Upon the failure of link 164, ADM 124 of node 144 detects no data and sends an AIS to the system. ADM 114 switches its data path through cable 162 under a preset APS scheme. The data travels to ADM 116 of node 146 where it is passed along its tributary links to ADM 126. ADM 126 switches the data onto cable 174. The data arrives at ADM 124 of node 144, thus circumventing the failure, and where it is switched onto cable 170. The data arrives at ADM 122 of node 152 to be sent along its normal path to data output ports 182.

In FIG. 6 a complete node site failure of node 144 occurs. Upon the failure of node 144, ADM 122 of node 152 detects no data and sends an AIS to the system. ADM 112 switches its data path through cable 161 under a preset APS scheme. The data travels to ADM 118 of node 148 where it is switched onto cable 171. The data arrives at ADM 116 of node 146. Normally, when data arrives at ADM 116, it is switched onto cable 162. However in this scenario since node 144 cannot receive data, ADM 122 will again send an AIS out to the system and upon reception of the AIS, ADM 116 will switch its data to be transmitted over its tributary links to ADM 126. Similarly, ADM 126 will attempt to transmit its data to node 144, this time over cable 174. Again ADM 122 will receive no data and send an AIS out to the system and upon reception of the AIS, ADM 126 will switch its data to be transmitted over cable 172 to ADM 128 of node 158 where it is switched to cable 176. The data arrives at ADM 122 of node 152, thus circumventing the failure, and is sent along its normal path to data output ports 182.

While the scenarios shown in FIGS. 3 through 6 are readily restorable assuming the traditional ring network switching behavior of the ADMs, there are other failure scenarios that present costly and potentially catastrophic outages which are difficult to repair and to restore transmission. For example, FIGS. 7 and 8 show failure scenarios for which restoration is not physically possible unless additional switching logic is employed beyond the usual ring network switching logic.

In FIG. 7 failures occur at cable 180 and cable pair 192. When this type of failure occurs, ADM 134 of node 154 will send an AIS to the system to attempt a rerouting of the data. Since data can only flow in one direction over the tributary links due to the inherent design of an ADM, an ADM can only transmit data in one direction and to specific outputs, ADM 132 of node 152 cannot reroute the data and the system cannot therefore recover from the failure.

In FIG. 8 failures occur at cable 170 and cable pair 190. When this type of failure occurs, ADM 122 of node 152 will send an AIS to the system to attempt a rerouting of the data. Again, data can only flow in one direction over the tributary links since an ADM can only transmit data in one direction and to specific outputs, ADM 124 of node 144 cannot reroute the data and the system cannot therefore recover from the failure.

Unless additional costly switching logic is employed beyond the usual ring switching logic, or unless bi-directional switching, advanced matched node software, or network protection equipment (NPE) is utilized, the failures in FIG. 7 and FIG. 8 cause an unrecoverable failure, also known as a data traffic outage. The failure scenarios depicted in FIGS. 3 through 8 are examples and are not meant to be inclusive of all possible failures.

It is therefore desirable to reduce the initial installation costs and recurring operating costs of a transoceanic system. It is also desirable to reduce the possibilities of data traffic outages due to occasional failures of cables and equipment.

### SUMMARY OF THE INVENTION

According to a first embodiment of the present invention, paired ADMs at a matched node site are replaced with a single switching device, such as a modified ADM or simple multiplexer. Furthermore, where a prior art three-ring network structure uses two fibers to form the interlink span (one for the backhaul ring and one for the transoceanic ring), a single fiber is used. This practice is particularly applicable to the transoceanic three-ring structure because there is normally no working traffic provisioned between adjacent matched-node sites. Furthermore, there is no increase to system robustness or reliability by using two fibers because, in practice, they are usually not diversely routed anyway.

A second embodiment of the present invention eliminates two of the terrestrial backhaul two-port nodes thus decreasing cost while increasing reliability and robustness. A two-port ADM contained in a two-port node does not add or drop any signals from the three ring system. The ADM at a two-port site merely passes data from one cable to another cable. The data stream can be routed directly from the previous node to the next node in the data path thus reducing the need for the additional ADM. In addition to the cost savings on the ADM, additional savings occurs because less cable is required to connect the two remaining nodes.

A third embodiment of the present invention utilizes multi-node rings. It replaces the two port nodes with three port nodes. Thus data either enters or leaves from four data ports in the network instead of two data ports.

According to a fourth embodiment of the present invention, the overall reliability of the system is increased to an even greater extent by replacing the single connection between the terrestrial sites with paired connections. Where the interlink span is desired to be particularly robust by virtue of diversely routed multiple cables, a 4-fiber bi-directional line switched ring (BLSR) network may be used for the terrestrial portions, and an ADM or optical cross-connect switch may be used to pass signals directly into the transoceanic links at a full aggregate rate rather than at a tributary rate.

These features and advantages of the present invention will be more readily apparent from the accompanying drawings and detailed description that follows.

### BRIEF DESCRIPTION OF THE DRAWINGS

The present invention is illustrated by way of example and not by way of limitation in the figures of the accompanying drawings. In the accompanying drawings similar references indicate similar elements. The drawings are described as follows:

FIG. 1 illustrates a traditional transoceanic cable system;

FIG. 2 is a block diagram illustration of the traditional three-ring architecture depicted in FIG. 1;

FIGS. 3 through 5 illustrate single point failures in the traditional transoceanic cable system;

FIG. 6 illustrates a catastrophic site failure in the traditional transoceanic cable system;

FIGS. 7 and 8 illustrate dual point failures in the traditional transoceanic cable system;

FIG. 9 illustrates a first embodiment of the present invention;

FIGS. 10 through 12 illustrate single point failures in the first embodiment of the present invention;

FIG. 13 illustrates a catastrophic site failure in the first embodiment of the present invention;

FIGS. 14 and 15 illustrate dual point failures in the first embodiment of the present invention;

FIG. 16 illustrates a three-node ring communications system according to another embodiment of the present invention;

FIG. 17 illustrates a bi-directional communications system according to a further embodiment of the present invention; and

FIG. 18 illustrates a 4-fiber bi-directional line switched ring (BLSR) configuration according to yet another embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

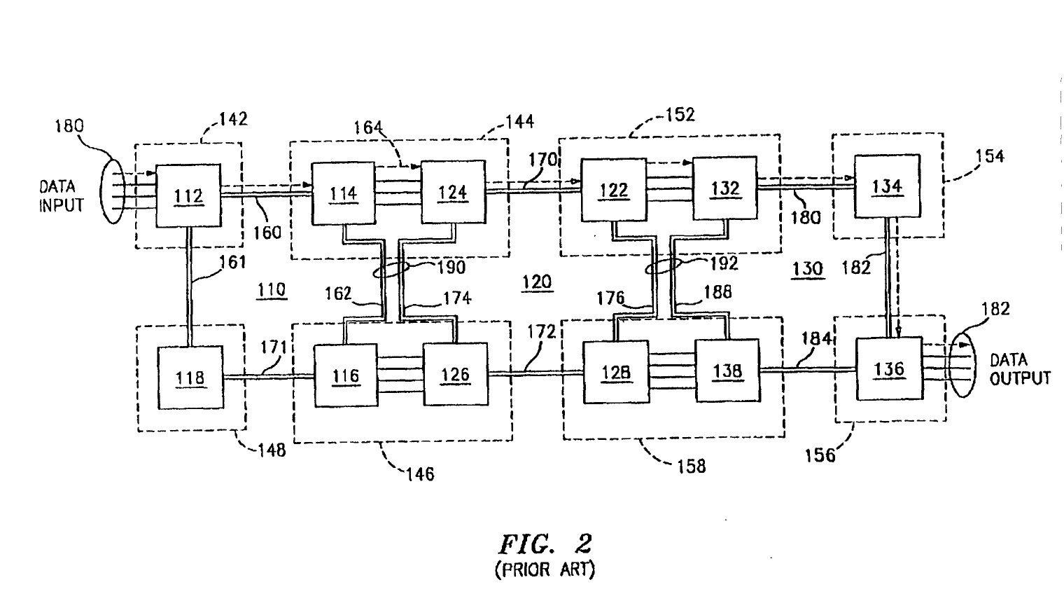

The present invention relates to a system for communicating between distant regions. The system utilizes a basic three ring network, wherein each ring network is comprised of at least three nodes. Each ring network, though connected to at least one node of another ring network, can be viewed as occupying a separate region from the other ring networks. The traditional three-ring architecture is depicted in FIG. 2, wherein three distinct rings are visible, i.e. backhaul rings 110 and 130, and transoceanic ring 120.

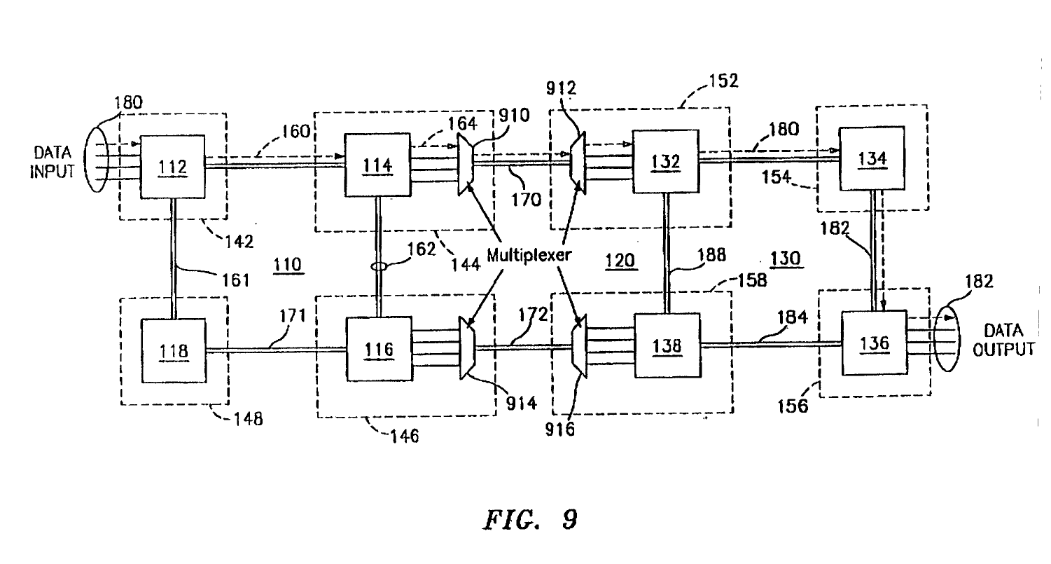

FIG. 9 depicts a first embodiment of the present invention. Cables 174 and 176 shown in FIG. 2 are no longer required. As shown in FIG. 9, only cables 162 and 188 remain. For the sake of clarity, the system will still be described as having three ring networks, each of which is located in a distinct region: a first ring network 110 in a first region, a second ring network 120 in a second region, and a third ring network 130 in a third region. Each ring network is comprised of at least three nodes.

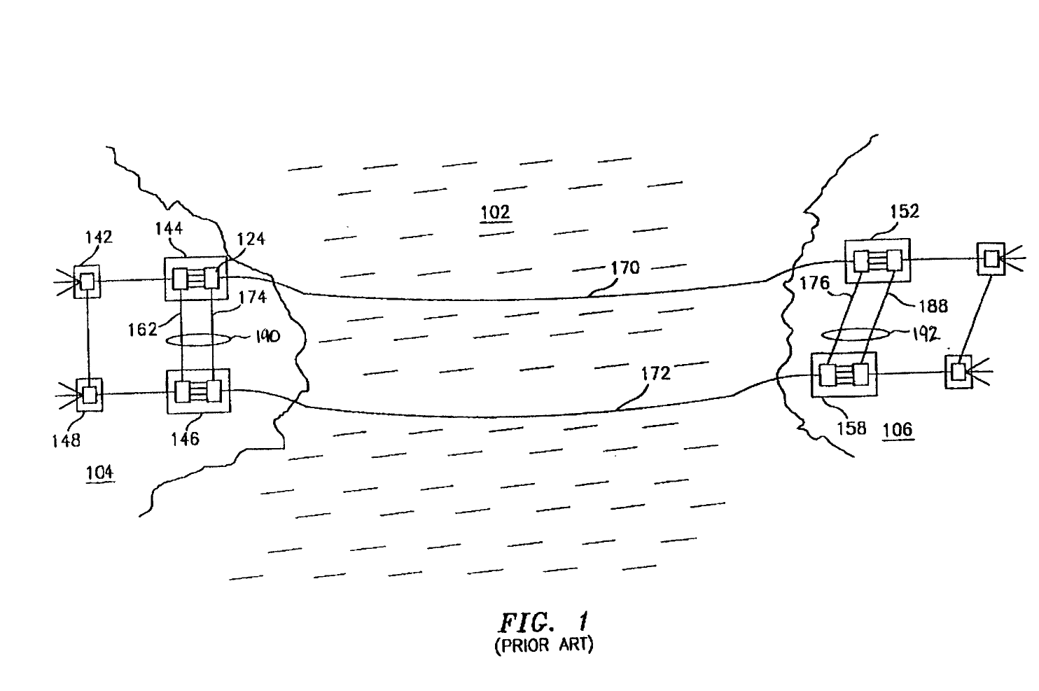

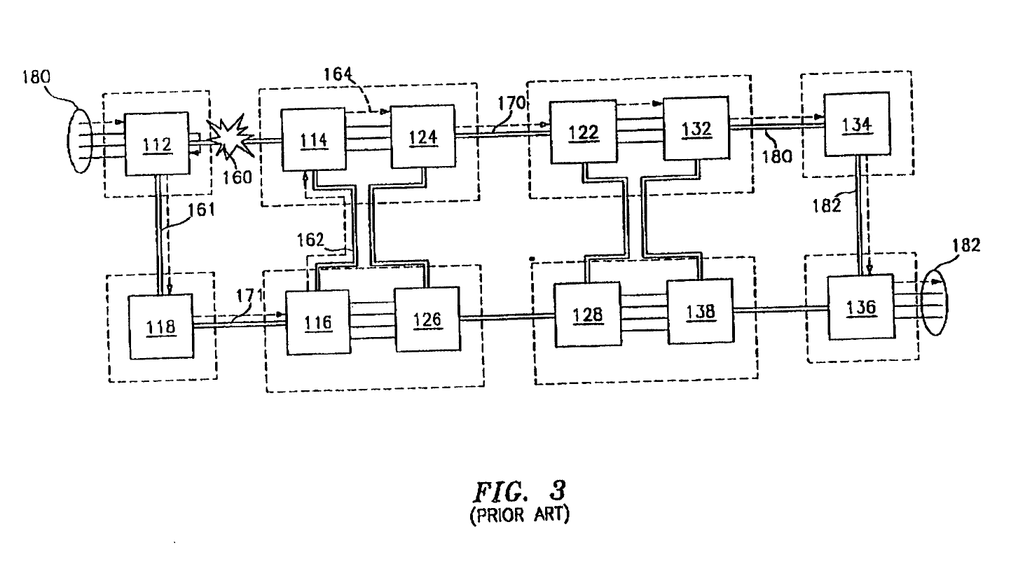

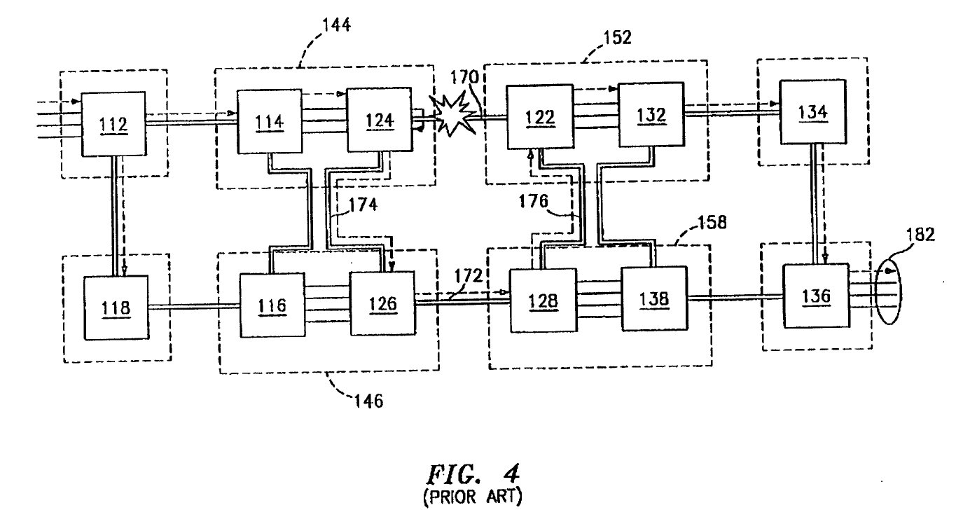

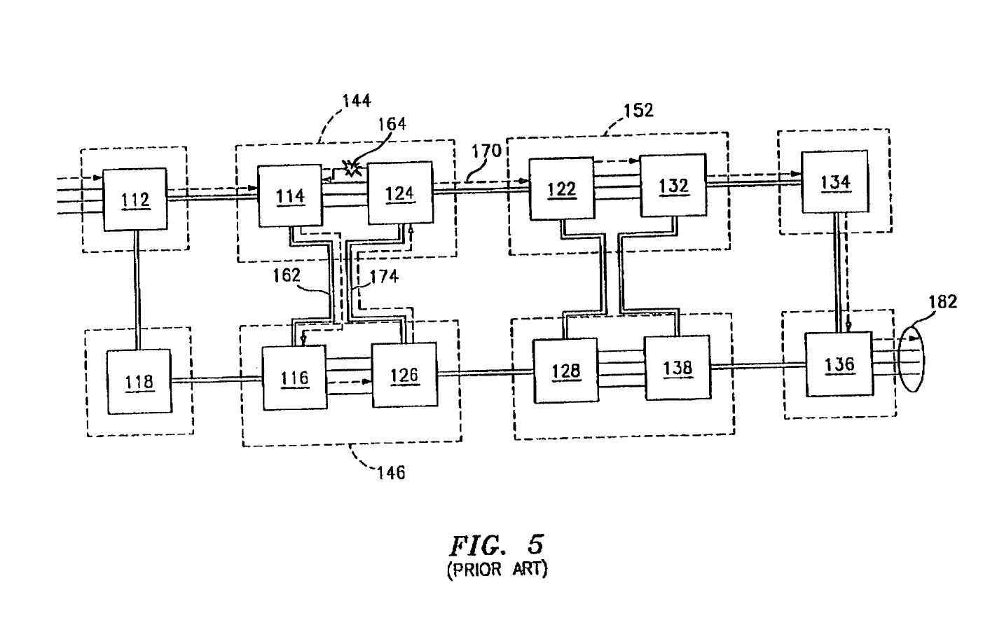

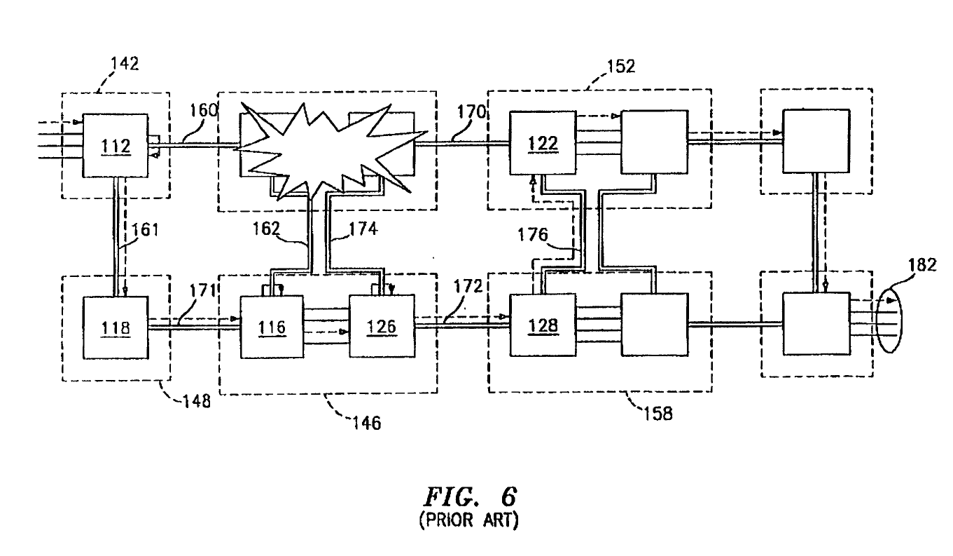

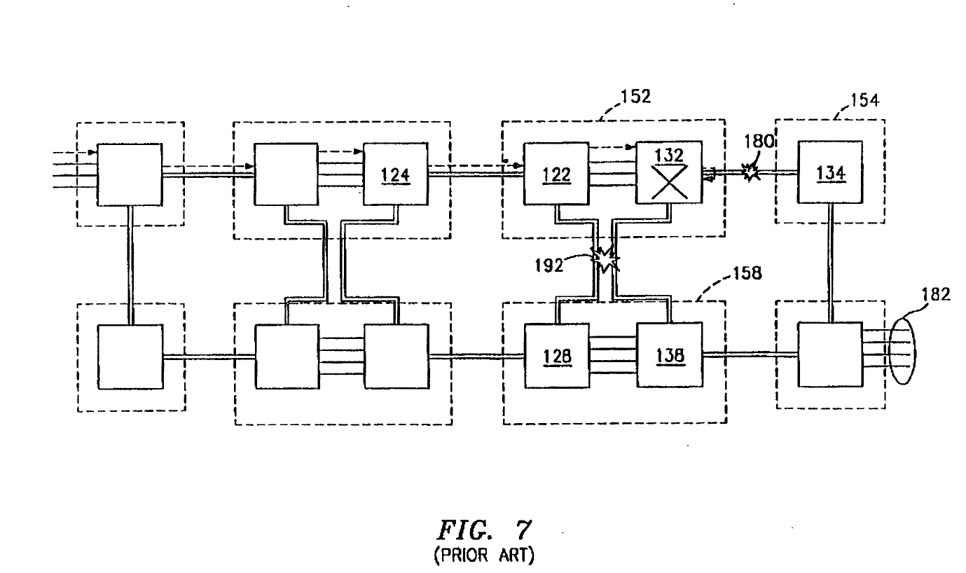

FIG. 9 illustrates an extended transport dual-junction architecture in accordance with a preferred embodiment of the present invention. The system depicted in FIG. 9 is comprised of eight ADMs (112, 114, 116, 118, 132, 134, 136 and 138) and four multiplexers (910, 912, 914, and 916). FIG. 9 depicts a four-node backhaul ring embodiment of the present invention. In contrast to the traditional three-ring architecture depicted in FIGS. 1 through 8, site 144 in FIG. 9 shows ADM 114 being coupled to a time-division multiplexer (TDM) 910 instead of a second ADM. Similarly, site 146 shows ADM 116 being coupled to TDM 914. TDM 910 and TDM 914 serve to recombine (multiplex) tributary data streams from ADM 114 and ADM 116, respectively, to yield an aggregate data stream to be transmitted along its respective transoceanic cable, i.e. 170 or 172. Where cable 170 or cable 172 is a fiber optic cable, an optical transmitter (not shown) is used to couple a modulated optical carrier into the fiber optic cable. At the other end of each transoceanic cable, ADM 122 and ADM 128 are replaced by TDM 912 and TDM 916, respectively. TDM 912 is used to adapt the received aggregate signal into the multiple tributaries expected by ADM 132, and TDM 916 is used to adapt an aggregate signal it receives into the multiple tributaries expected by ADM 138. TDM 910, TDM 914, TDM 912 and TDM 916 are depicted in FIG. 9 as separate elements for the purpose of parity with the traditional three-ring architecture of FIG. 1, but the multiplexing/demultiplexing functions can be accomplished with separate equipment, as shown in FIG. 9, or can be incorporated directly into the ADM switch element.

Referring again to FIG. 9, under normal operating conditions data enters the system at data input ports 180 at node 142 wherein ADM 112 multiplexes the data and transmits the data through conduit 160 to node 144. When the data arrives at node 144, ADM 114 demultiplexes the data and transmits the demultiplexed data to TDM 910. TDM 910 multiplexes the data and transmits the data through cable 170 to TDM 912 of node 152. TDM 912 demultiplexes the data and transmits the data to ADM 132, which in turn transmits the data to ADM 134 of node 154. ADM 134 transmits the data to ADM 136 of node 156 which outputs the data at output ports 182 where it is routed to other networks of the system.

One advantage of the embodiment of FIG. 9 is that existing installations and ADM equipment are readily convertible. Another notable difference between the embodiment shown in FIG. 9 and the prior art shown in FIGS. 1 and 2 is the elimination of interlink connection 174 between sites 144 and 146 and interlink connection 176 between sites 152 and 158 that were previously dedicated to the formation of the transoceanic ring. By eliminating the ADMs and the additional cables, the cost of the system is greatly reduced and the reliability of the system is increased. The cost reduction is due to the use of less ADMs and cable; the reliability is increased due to the fact that there are fewer components prone to failure, and more importantly, the system can recover from failures that the traditional three-ring structure could not as described below.

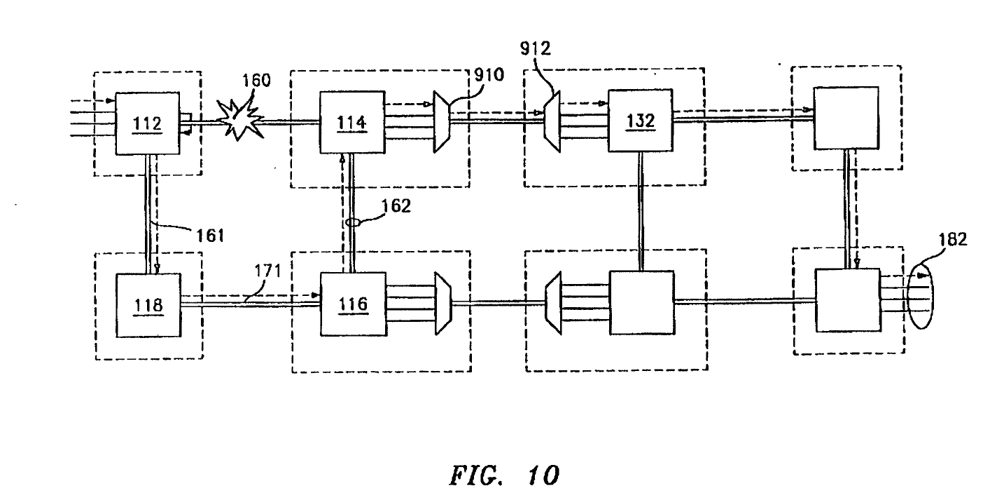

FIGS. 10 through 15 depict the communications system of FIG. 9 under various failure scenarios.

Shown in FIG. 10 is a failure of cable 160. ADM 114 sends an AIS to the system and ADM 112 switches its data path to cable 161. The data passes through ADM 118, across cable 171 and to ADM 116. ADM 116 switches the data to cable 162 and on to ADM 114, thus circumventing the failure. The data is then routed along its normal data path to output ports 182.

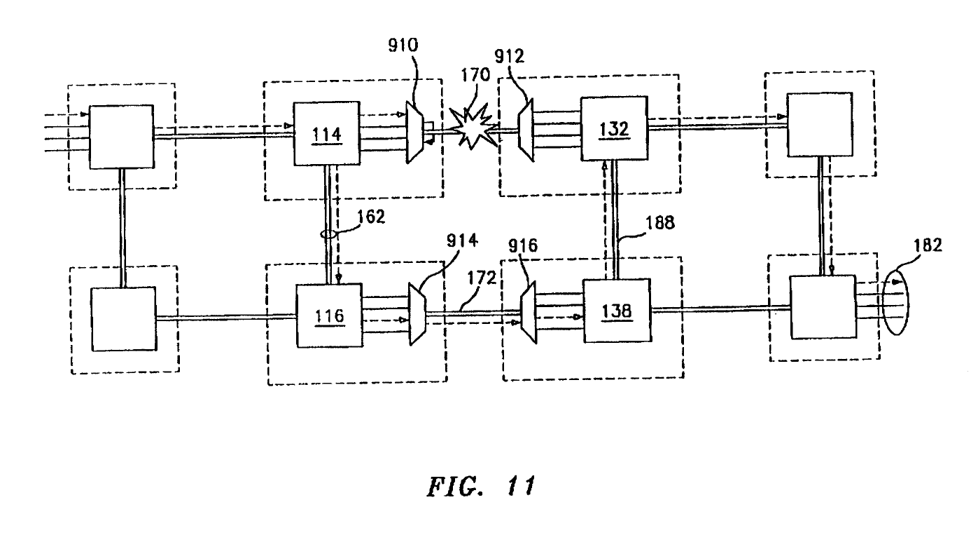

FIG. 11 depicts a situation where one of the transoceanic cables fails. Referring to FIG. 11, transoceanic cable 170 experiences a failure. An AIS is sent through the system by ADM 132 informing ADM 114 that ADM 132 is not receiving data. ADM 114 switches its data route to cable 162. When the data arrives at ADM 116, it sends the data across tributary links to TDM 914. TDM 914 multiplexes the data and routes the data across cable 172 to TDM 916. TDM 916 demultiplexes the data and routes it to ADM 138. The data is sent along cable 188 to ADM 132, thus circumventing the failure, and where it is routed along its normal data path to output ports 182.

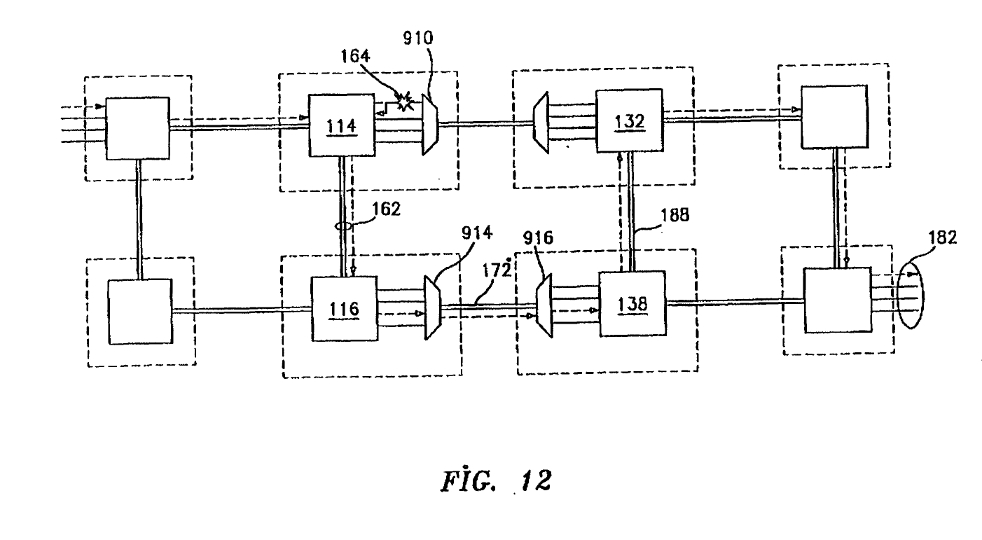

FIG. 12 depicts a tributary interconnect link failure. Link 164 experiences a failure. ADM 132 notifies the system that it is not receiving data. ADM 114 switches its data to output onto cable 162. The data routes through ADM 116, through its tributaries where it is multiplexed by TDM 914. The data is routed along transoceanic cable 172 to TDM 916 where it is converted to tributary data for ADM 138. ADM 138 switches the data to cable 188 to ADM 132, thus circumventing the failure, and where it continues on its normal path to output ports 182.

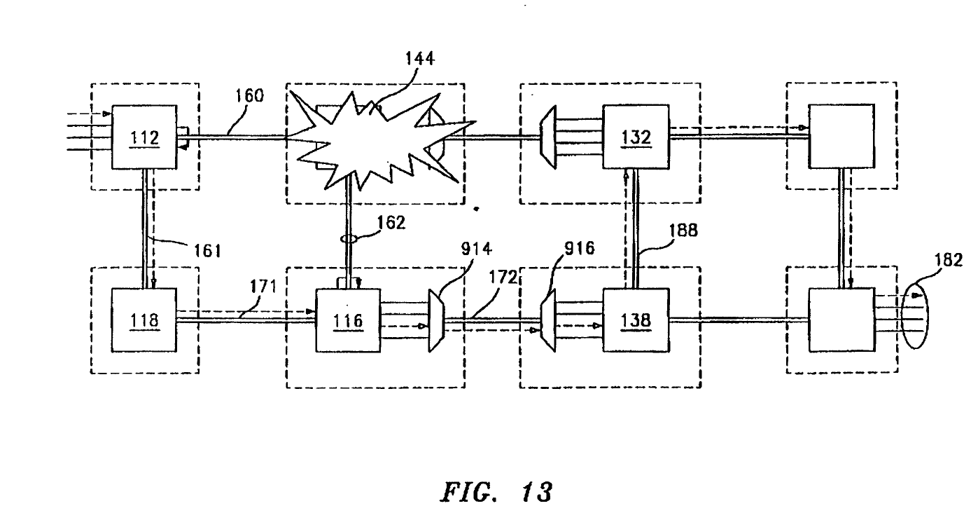

FIG. 13 depicts a node site failure. Referring to FIG. 13, a failure occurs at node site 144. An AIS is transmitted to the system by ADM 132 causing ADM 112 to switch its data path from cable 160 to cable 161. The data passes from cable 161 through ADM 118 and onto cable 171. Since data cannot pass along cable 162, ADM 116 switches its data path from cable 162 to its tributary links along to TDM 914. The aggregate data is transmitted along transoceanic cable 172 where it arrives at TDM 916. TDM 916 demultiplexes the data and passes it along to ADM 138. ADM 138 transmits the data onto cable 188. ADM 132 receives the data, thus circumventing the failure, and where it then continues on its normal path to output ports 182.

The failures depicted in FIGS. 10 through 13 depict failures for which the conventional ring switching logic, AIS and APS schemes of the ADMs and system suffice to maintain communications. They are not intended to depict all possible failure scenarios.

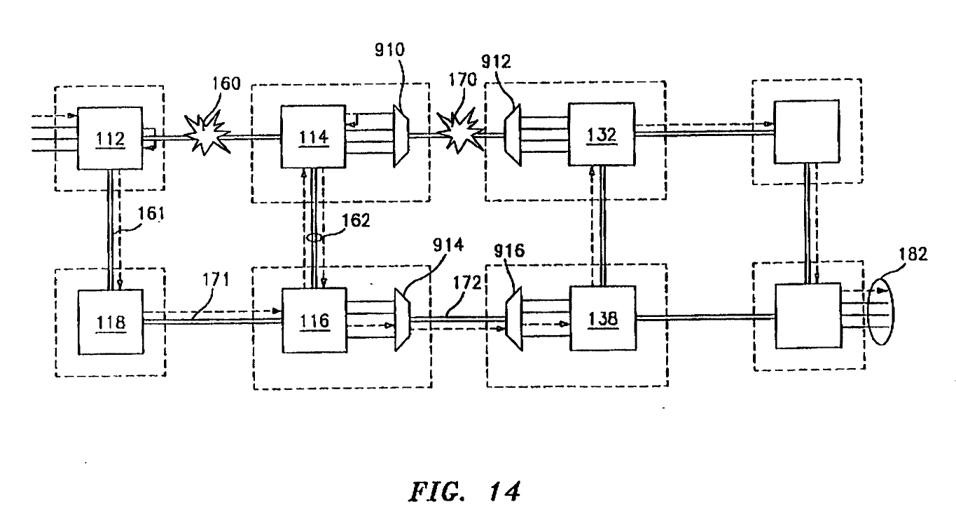

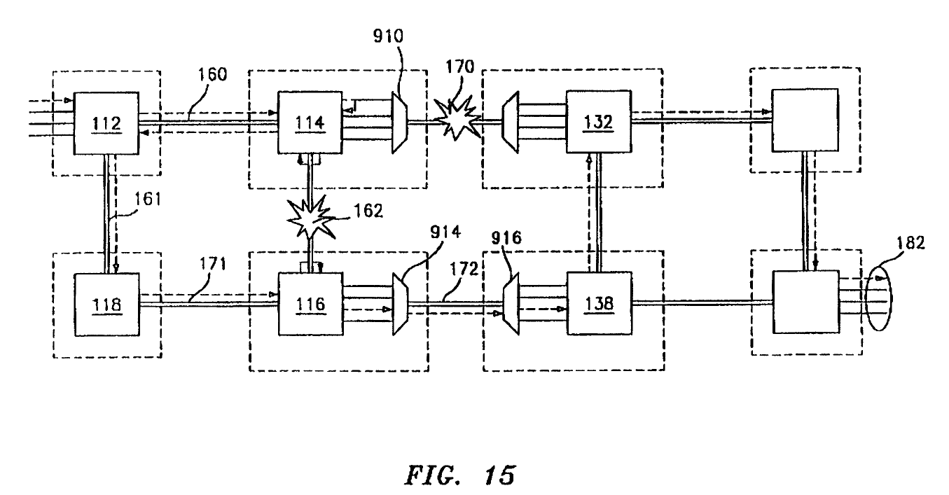

FIGS. 14 and 15 depict dual failures experienced by the communications system of FIG. 9. In the traditional three-ring architecture, these types of failures will result in a data traffic outage. By implementing the present invention, dual failure scenarios that traditionally result in data traffic outages are restorable by appropriate switching actions. The switching actions can be automatically implemented through an APS scheme, or through a manual control switching station.

Referring to FIG. 14, when a dual failure of cable 160 and transoceanic cable 170 occurs data is routed along the path shown by the dashed line and rerouted to output ports 182. ADM 132 communicates an AIS signal to the system indicating that the former is not receiving any data signals from any of the other nodes in the ring. ADMs 114 and 116 then coordinate to drop the signal at ADM 116 and transmit through cable 172 to ADM 138 where it may then reach its intended destination, output ports 182. By removing ADM 124 from the system and replacing it with TDM 910, the system can recover from the failure since the switching is now controlled only by ADM 114. If ADM 124 were still in the system, it would be unable to reroute the data back to ADM 114 due to its inherent switching constraints.

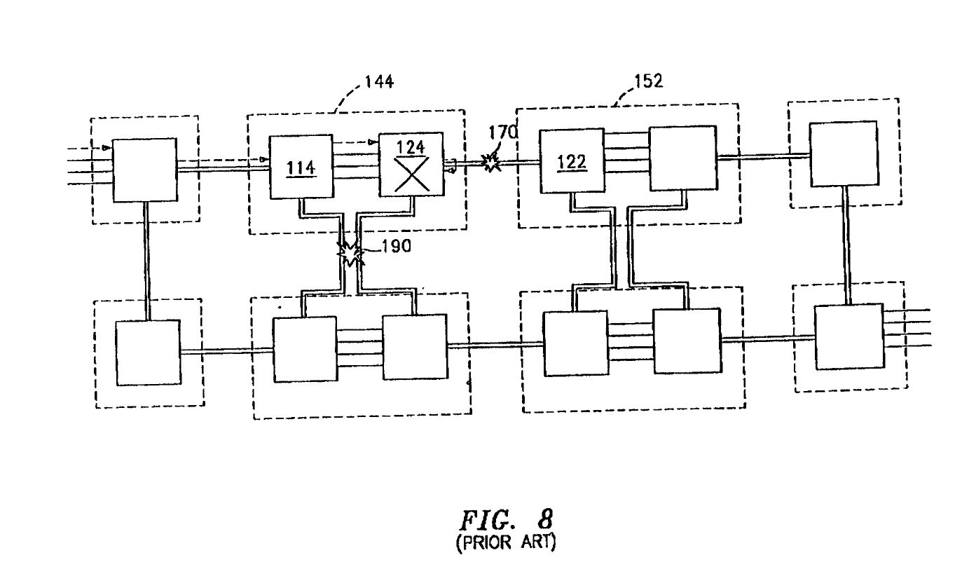

FIG. 15 depicts another dual failure scenario that traditionally results in traffic outage, but with the implementation of the present invention, even with complete faults to cables 162 and 170, data traffic is still restorable by the appropriate switching actions. When a dual failure of cable 170 and cable 162 occurs, ADM 132 notifies the system of data loss. As depicted in FIG. 8, if ADM 124 were still present, the system would fail because the data can only flow one direction over the tributary links due to the design constraints of an ADM, and a data outage would occur. With the removal of ADM 124 and its replacement by TDM 910, ADM 114 can now handle the required switchover back through cable 160 to ADM 112. ADM 112 routes the data over cable 161 to ADM 118 where it is passed along onto cable 171. ADM 116 receives the data and attempts a switch to cable 162. If the attempt was made, an AIS would occur, and ADM 116 would then switch the data to its tributary links to TDM 914. The data travels across cable 172 to TDM 916 where it is demultiplexed and forwarded to ADM 138. ADM 138 switches the data to ADM 132 where it is routed along its normal data path to output ports 182, circumventing the failure and avoiding a data outage.

Another advantage of the present invention is that full aggregate data can be transmitted across the tributary links of link 164 and its counterparts contained in the other nodes. If one of the links fail the full aggregate data can easily be rerouted by an intranodal switch, rather than an internodal switch, to another tributary link, thus avoiding any further switching.

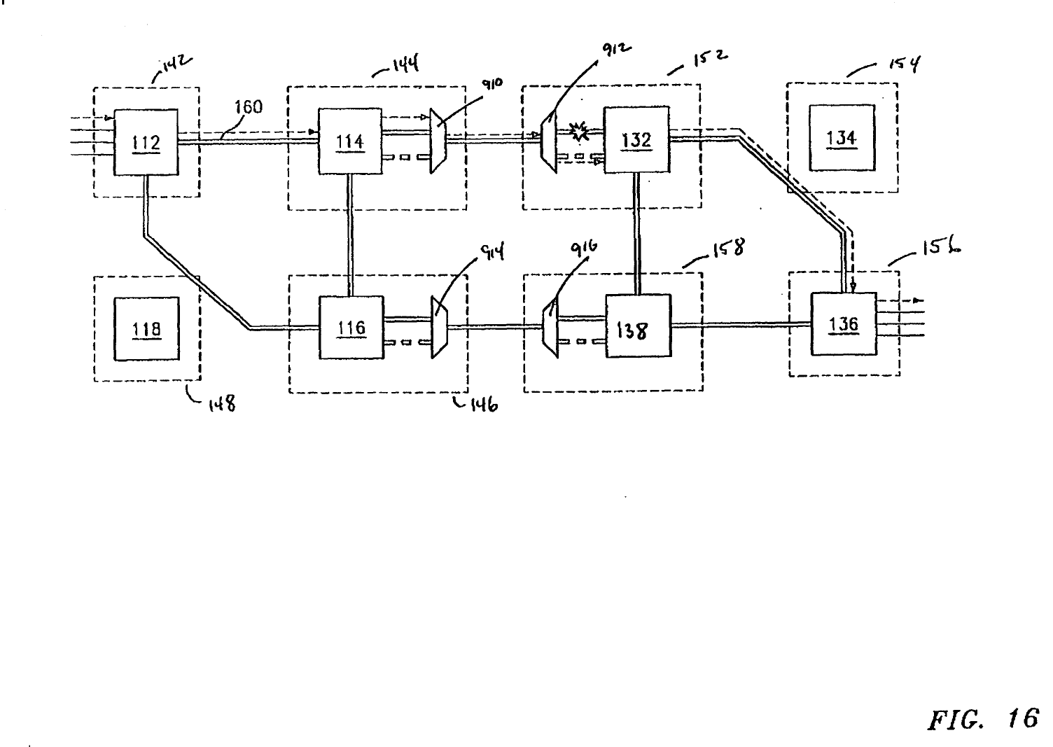

In the three-node embodiment of the present invention depicted in FIG. 16, node 148 and ADM 118 are removed and a direct connection is made between node 142 and node 146. Similarly, node 154 and ADM 134 are removed and a direct connection is made between node 152 and node 156. Since, in the traditional configuration, ADM 118 and ADM 134 (depicted in the figure only for clarity, but not in ultimate design) merely serve to pass data along to ADM 116 and ADM 136, respectively, ADM 118 and ADM 134 are unnecessary components in the overall system. By eliminating ADM 118 and ADM 134 their costs are eliminated. Also, the system is more reliable in that there are now two less components that may experience failure. Furthermore, by eliminating the two ADMs, the cable connecting ADM 112 to ADM 116 and the cable connecting ADM 132 to ADM 136 can be shorter thereby further decreasing the cost of the system.

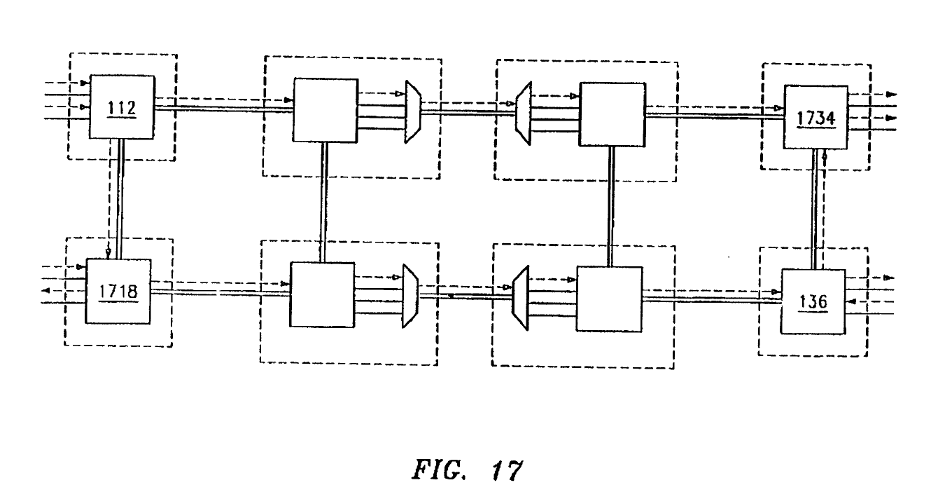

FIG. 17 depicts a multi-node ring configuration of the present invention. Even though a single direction of communications has been shown for clarity, those of ordinary skill in the relevant art will readily recognize that the present invention may achieve reliable bi-directional communications between two regions with little to no adaptation beyond what has already been taught herein. The system of FIG. 17 replaces the two port nodes (i.e. ADM 118 and ADM 134) with three port nodes (i.e. ADM 1718 and ADM 1734). Thus data either enters or leaves from four data ports in the network instead of two data ports adding further flexibility to the overall system. This system operates as described above.

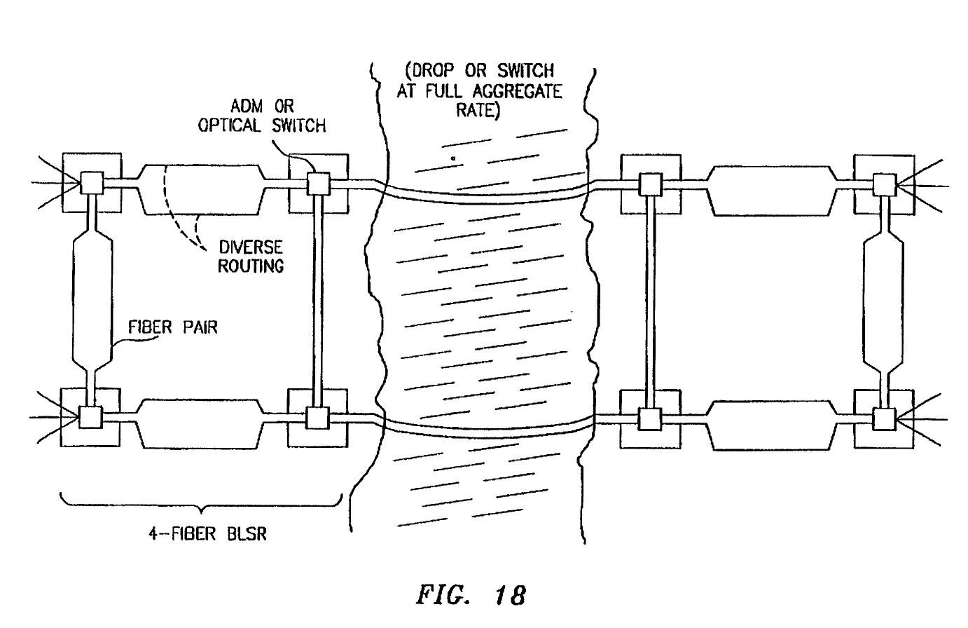

FIG. 18 depicts a fourth embodiment of the present invention. The overall reliability of the system is increased to an even greater extent by replacing the single connection between the terrestrial sites with paired connections. Where the interlink span is desired to be particularly robust by virtue of diversely routed multiple cables, a 4-fiber bi-directional line switched ring (BLSR) may be used for the terrestrial portions, and an ADM or optical cross-connect switch may be used to pass signals directly into the transoceanic links at a full aggregate rate rather than at a tributary rate. The overall system depicted in FIG. 18 operates as that shown in FIG. 9. Though the cost of the additional cables increases the overall system costs, the increase in system reliability balances any additional costs.

While a preferred embodiment of the present invention has been shown and described in the context of a transoceanic cable, those of ordinary skill in the art will recognize that the present invention may be applied to achieving reliable communications through any form of information conduit across a span where the conduits are not readily accessible and it is impractical or impossible to employ intermediate sites to act upon the information traffic, thus resulting in improved robustness and reliability to the overall system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A system for communicating between distant regions, the system having at least one input port and at least one output port, the system comprising:
a first ring network comprising at least three first ring switching devices located in a first region, each of the first ring switching devices being connected to at least two of the other first ring switching devices;
a second ring network comprising at least three second ring switching devices located in a second region, each of the second ring switching devices being connected to at least two of the other second ring switching devices; and
a third ring network having two interconnected pairs of switching devices, a first interconnected pair of switching devices being connected between one first ring switching device and one second ring switching device, and a second interconnected pair of switching devices being connected between another first ring switching device and another second ring switching device;
wherein each switching device of the two interconnected pairs of switching devices enables bi-directional data transfer between itself and its connected first ring and second ring switching device.

2. The system of claim 1, wherein each of the at least three first ring switching devices and each of the at least three second ring switching devices are add-drop multiplexers.

3. The system of claim 2, wherein each switching device of the two interconnected pairs of switching devices is a time-division multiplexer.

4. The system of claim 3, wherein the time-division multiplexer is one of an optical time-division multiplexer and an electrical time-division multiplexer.

5. The system of claim 3, wherein the connection between each time-division multiplexer and each add-drop multiplexer comprises multiple connections each of which carries a percentage of total data being communicated.

6. A system for communicating between distant regions, comprising:
a first ring network having at least one data input/output port;
a second ring network having at least one data input/output port; and
a third ring network having two interconnected pairs of switching devices, a first interconnected pair of switching devices being connected between the first ring network and the second ring network, and a second interconnected pair of switching devices being connected between the first ring network and the second ring network;
wherein each switching device of the two interconnected pairs of switching devices enables bi-directional data transfer between itself and the first ring network and the second ring network.

7. The system of claim 6, wherein the first ring network and the second ring network each comprise at least three add-drop multiplexers.

8. The system of claim 7, wherein each switching device of the two interconnected pairs of switching devices is a time-division multiplexer.

9. The system of claim 8, wherein the time-division multiplexer is one of an optical time-division multiplexer and an electrical time-division multiplexer.

10. A system for communicating between a first region and a second region, the system having at least two conduits for carrying data, each conduit spanning between the first region and the second region, and each conduit having two ends, the system comprising:
at least four bi-directional switching devices, each end of the at least two conduits being connected to one of the at least four bi-directional switching devices;
at least six add-drop multiplexers, each of four of the at least six add-drop multiplexers being connected to one of the at least four bi-directional switching devices, and one add-drop multiplexer located in each region being interconnected with two of the add-drop multiplexers in each region; and
at least one input/output data port located in each region and connected to at least one add-drop multiplexer;
wherein each of the four bi-directional switching devices can transfer data to and from itself and the add-drop multiplexer connected thereto.

11. The system of claim 10, wherein the bi-directional switching devices are time-division multiplexers.

12. A communications network, the communications network having at least three add-drop multiplexers located in a first region, at least three add-drop multiplexers located in a second region, at least three data conduits located in the first region, at least three data conduits located in the second region, each data conduit connected to two add-drop multiplexers located in its corresponding region, at least two switching elements located in the first region, at least two switching elements located in the second region, each switching element being connected to one add-drop multiplexer in its corresponding region and connected to one switching element of a non-corresponding region, wherein each switching element facilitates bi-directional data transfer between itself and the add-drop multiplexer connected thereto.

13. A method of restoring data transmission in a communications network in the event of a failure in data conduits of the network, the communications network having at least three add-drop multiplexers interconnected by data conduits located in a first region, at least three add-drop multiplexers interconnected by data conduits located in a second region, at least two bi-directional switching elements located in the first region, and at least two bi-directional switching elements located in the second region, each bi-directional switching element in the first region being connected via tributary links to one add-drop multiplexer in its corresponding region and connected to one bi-directional switching element of the second region, the failure occurring such that at least one of the add-drop multiplexers and switching elements becomes isolated from the remaining network except for a tributary link, the method comprising the steps of:
sending by an add-drop multiplexer an alarm through the network signaling a preceding add-drop multiplexer that the sending add-drop multiplexer is not receiving data; and
switching the data path in a bi-directional manner across the tributary links restoring data routing through the communications network.
